(19) United States
(12) Patent Application Publication
(10) Pub. No.: US 2026/0166454 A1
(43) Pub. Date: Jun. 18, 2026

(54) FILTER DEVICE FOR A FLUID, AND HOUSING PORTION AND FILTER ELEMENT FOR A FILTER DEVICE

(71) Applicant: MANN+HUMMEL GmbH, Ludwigsburg (DE)

(72) Inventor: Benedikt WELLER, Steinheim (DE)

(21) Appl. No.: 19/533,942

(22) Filed: Feb. 9, 2026

Related U.S. Application Data
(63) Continuation of application No. PCT/EP2024/073523, filed on Aug. 22, 2024.

(30) Foreign Application Priority Data
Aug. 23, 2023 (DE) 10 2023 122 548.0

(51) Int. Cl. B01D 29/96; B01D 29/15; B01D 35/30

(52) U.S. Cl. CPC B01D 29/96; B01D 29/15; B01D 35/306; B01D 2201/0415; B01D 2201/301; B01D 2201/4046

(57) ABSTRACT

A filter device has a housing portion with an inlet and a central outlet for fluid. A housing cover is configured to receive a filter element and is mountable to the housing portion, which has a blocking device operatively connected to an actuation device of the filter element when the housing cover is mounted to the housing portion. The blocking device permits mounting of the housing cover in a release position and blocks mounting of the housing cover in a blocking position. A housing portion for such a filter device is provided with an inlet and a central outlet for fluid and a blocking device to be operatively connectable to the actuation device of the filter element. A filter element for such a filter device is provided received in the housing cover and mounted together with the housing cover on the housing portion.

### CROSS-REFERENCE TO RELATED APPLICATIONS

This application is a continuation application of international application No. PCT/EP2024/073523 having an international filing date of Aug. 22, 2024 and designating the United States, the international application claiming a priority date of Aug. 23, 2023 based on prior filed German patent application No. 10 2023 122 548.0, the entire contents of the aforesaid applications being incorporated herein by reference to the fullest permitted extent.

### BACKGROUND

The invention concerns a filter device for a fluid, for example for a liquid fluid, and a housing portion and a filter element for a filter device.

US 2014/0360929 A1 discloses a filter device which includes a filter receptacle with a receptacle wall and a circular edge, defining an opening for receiving a filter cartridge, and a first interlock device coupled to the receptacle wall of the filter receptacle. The first interlock device includes a first actuating element movable between a first position and a second position and biased into the first position. In this context, at least a portion of the first actuating element protrudes from the receptacle wall in the first position. The first interlock device is configured such that, when a filter cartridge is inserted into the filter receptacle, the first actuating element is moved by the filter cartridge from the first position to the second position and is held in the second position by the filter cartridge.

### SUMMARY

It is an object of the invention to provide an improved filter device for a fluid, for example for a liquid fluid.

It is a further object of the invention to provide a housing portion for such a filter device.

It is a further object of the invention to provide a filter element for such a filter device.

The aforementioned object is solved according to an aspect of the invention by a filter device for a fluid, for example for a liquid fluid, including a housing portion which includes at least one inlet for the fluid to be filtered and at least one central outlet for the filtered fluid, and which is connected or connectable to a housing cover configured to receive an exchangeable filter element in its interior, wherein the housing portion includes a blocking device which is operatively connected to an actuation device of the filter element when connecting the housing cover and the housing portion as intended, wherein the blocking device permits mounting of the housing cover in a release position and blocks mounting of the housing cover in a blocking position.

According to a further aspect of the invention, the further object is solved by a housing portion for a filter device, including at least one inlet for a fluid to be filtered and at least one central outlet for the filtered fluid, at least including a blocking device which is operatively connected to an actuation device of a filter element when connecting the housing cover and the housing portion as intended, wherein the blocking device permits mounting of the housing cover in a release position and blocks mounting of the housing cover in a blocking position.

According to a further aspect of the invention, the further object is solved by a filter element for a filter device which is configured to be received in an interior of a housing cover of the filter device, wherein the housing cover with the filter element may be mounted on a housing portion, at least including an actuation device which, when connecting the housing cover and the housing portion as intended, is operatively connected to a blocking device arranged in the housing portion.

Embodiments and advantages of the invention result from the following descriptions and the accompanying drawings.

According to an aspect of the invention, a filter device for a fluid, for example for a liquid, is proposed, including a housing portion which includes at least one inlet for the fluid to be filtered and at least one central outlet for the filtered fluid, and which is connected or connectable to a housing cover configured to receive an exchangeable filter element in its interior. The housing portion includes a blocking device which is operatively connected to an actuation device of the filter element when connecting the housing cover and the housing portion as intended. In this context, the blocking device permits mounting of the housing cover in a release position and blocks mounting of the housing cover in a blocking position.

The proposed filter device includes a housing portion with an integrated blocking device, which, for example, may be designed as a spring-biased sheet-metal structure, and a corresponding actuation device at a filter element. The filter element may include plastic end discs, for example. The filter device may be designed, for example, for a use in the field of oil filtration or fuel filtration or for air oil separation.

The blocking device, for example, may be designed as a flower-like structure and include a blocking position and a release position. The transition between blocking position and release position is realized by guide elements in the housing portion against the biasing force of the spring-biased structure. Arranged at the actuation device, the filter element includes a structure in accordance with a lock-and-key principle in the form of guide receptacles, which structure corresponds to a structure of guide ribs in the housing portion. In this way, a position-correct positioning of the filter element upon installation in the housing portion may be achieved. Should no filter element be arranged in the housing cover or a filter element with a structure that does not fit, the blocking device blocks the thread and thus mounting of the housing cover. The filter device thus provides a protective function because the housing cover cannot be mounted without filter element. By means of a further housing-side rib, which engages the blocking device from a radially outward position, it may be prevented that the actuation of the blocking device is enabled by the use of a hollow-cylindrical actuation device at a filter element. The blocking device may be actuated only with an actuation device with matching guide receptacles as key structure.

The blocking device may be detachably or non-detachably connected to the housing portion.

According to an embodiment of the filter device, the blocking device may be arranged in the housing portion so as to surround the outlet and to be slidable along a housing axis between the release position and the blocking position. In this context, the blocking device may be movable by the actuation device into the release position. For example, the blocking device, when not operatively connected to the actuation device, may be in the blocking position. For example, in this context the blocking device, when not operatively connected to the actuation device, may pass automatically from the release position into the blocking position. In this manner, the blocking device may prevent mounting of the housing cover when the blocking device is not moved by the actuation device of a filter element installed in the housing cover from the blocking position into the release position.

For example, the blocking device may be pushed in the housing axis into the release position when, upon mounting of the housing cover, the filter element is arranged in the housing cover. In the non-actuated state, the blocking device by itself returns into the blocking position and remains therein. For this purpose, the blocking device may be expediently spring-biased in the blocking position.

According to an embodiment of the filter device, the blocking device may include at least two spring arms protruding in radial direction. For example, the spring arms may rest against an inner housing wall in the blocking position. The spring arms, in the state not actuated by the actuation device of the filter element, may prevent an engagement of the thread of the housing cover in a counter thread of the housing portion and thus prevent mounting of the housing cover.

According to an embodiment of the filter device, the housing portion may include axially arranged guide elements by means of which the at least two spring arms, when transitioning from the blocking position into the release position, are disengaged from the inner housing wall and folded inwardly in radial direction. In this manner, the spring arms of the blocking device may be expediently folded so that the thread of the housing cover may engage the counter thread of the housing portion and the housing cover may be mounted on the housing portion.

According to an embodiment of the filter device, the blocking device may include at least one spring element, for example acting in the housing axis, by means of which the blocking device, when not operatively connected to the actuation device, may be automatically moved from the release position into the blocking position. By means of the spring element which may be configured, for example, as a pressure spring or leaf spring, the required pretension may be produced in order to push the blocking device in the non-actuated state from the release position into the blocking position.

According to an embodiment of the filter device, the outlet may include at least one radially protruding guide rib which extends in the housing axis, wherein the blocking device includes at least one corresponding cutout. In this context, the blocking device with the at least one cutout may be slidable along the guide rib. In this way, the movement of the blocking device from the release position into the blocking position and back may be reliably guided. The at least one guide rib may be designed as a key structure for a position-correct mounting of the filter element and may engage a corresponding receptacle of the actuation device of the filter element.

According to an embodiment of the filter device, the actuation device may include guide receptacles which correspond to the guide ribs when mounted as intended. In this context, the guide ribs may interact with the guide receptacles when mounting the housing cover with the filter element as intended. For example, the guide ribs may engage the guide receptacles. The guide ribs may be configured as a key structure for a position-correct mounting of the filter element and may engage corresponding guide receptacles of the actuation device of the filter element.

According to an embodiment of the filter device, the housing portion may include at least one positioning element protruding in radial direction inwardly and extending in the housing axis, wherein the actuation device of the filter element includes at least one recess which is engaged by the positioning element when mounting the filter element as intended. By means of a further housing-side rib as positioning element which engages the blocking device from a radially outward position, it may be prevented that the actuation of the blocking device is possible by the use of a hollow cylindrical actuation device at a filter element. The blocking device may be actuated only with an actuation device with a matching recess as a key structure.

According to an embodiment of the filter device, the actuation device may be configured to surround the outlet when mounted as intended, wherein a bottom rim of the actuation device moves the blocking device in the housing axis when mounted as intended. In this manner, a suitable flow of the filtered fluid out of the filter element into the outlet and, moreover, an actuation of the blocking device may be ensured.

According to an embodiment of the filter device, the actuation device may include a circumferentially closed contour extending along the housing axis and/or include stays and/or pins extending along the housing axis. The actuation device may thus be differently designed and nonetheless actuate in a suitable manner the blocking device in order to move it from the blocking position into the release position.

According to an embodiment of the filter device, the actuation device may be configured as part of a central tube and/or as part of an end disk of the filter element. In this way, the actuation device may be reliably and permanently connected to the filter element. In addition, manufacturing costs in the production and mounting of the actuation device may thus be saved in a beneficial manner.

According to a further aspect of the invention, a housing portion for a filter device is proposed, including at least one inlet for a fluid to be filtered and at least one central outlet for the filtered fluid. The housing portion includes at least one blocking device which is operatively connected to an actuation device of a filter element when connecting a housing cover and the housing portion as intended. In this context, the blocking device permits mounting of the housing cover in a release position and blocks mounting of the housing cover in a blocking position.

The proposed housing portion includes an integrated blocking device which, for example, may be configured as a spring-biased sheet-metal structure. The blocking device may be configured, for example, as a flower-like structure and include a blocking position and a release position. The transition between blocking position and release position is realized by guide elements in the housing portion against the pretension force of the spring-biased structure.

In this way, a position-correct positioning of a filter element upon installation in the housing portion may be achieved. When no filter element is arranged in the housing cover or a filter element with a structure that does not match, the blocking device blocks the thread and thus mounting of the housing cover. The filter device with the proposed housing portion thus provides a protective function because the housing cover cannot be mounted without the filter element.

According to a further aspect of the invention, a filter element for a filter device is proposed which is configured to be received in an interior of a housing cover of the filter device, wherein the housing cover with the filter element may be mounted on a housing portion. The filter element includes at least one actuation device which, upon connecting the housing cover and the housing portion as intended, is operatively connected to a blocking device arranged in the housing portion.

The filter element includes a structure according to the lock-and-key principle which is arranged at the actuation device and in the form of guide receptacles which correspond to a structure of guide ribs in the housing portion. In this way, a position-correct positioning of the filter element upon installation in the housing portion may be achieved. When no filter element is arranged in the housing cover or a filter element with a structure that does not match, the blocking device blocks the thread and thus mounting of the housing cover. The filter device thus provides a protective function because the housing cover cannot be mounted without filter element.

The actuation device may be configured as part of a central tube and/or as part of an end plate of the filter element.

### BRIEF DESCRIPTION OF THE DRAWINGS

Further advantages result from the following descriptions and the accompanying drawings. In the drawings, embodiments of the invention are illustrated. The drawings and the descriptions contain numerous features in combination. A person of skill in the art will consider the features expediently also individually and combine them to expedient further combinations.

FIG. 1 shows a side view of a filter device for a fluid, for example for a liquid fluid, according to an embodiment of the invention with a housing cover unscrewed.

FIG. 2 shows a plan view of the housing cover of the filter device according to FIG. 1.

FIG. 3 shows a section illustration of the filter device in the section plane III-III according to FIG. 1.

FIG. 4 shows a further section illustration of the filter device in the section plane IV-IV according to FIG. 2.

FIG. 5 shows a further section illustration of the filter device in the mounted state with screwed-in housing cover in the section plane V-V according to FIG. 1.

FIG. 6 shows a further section illustration of the filter device in the mounted state in the section plane VI-VI according to FIG. 2.

FIG. 7 shows a further section illustration of the filter device in the mounted state in the section plane VII-VII according to FIG. 2.

FIG. 8 shows an isometric view of a housing portion according to an embodiment of the invention with a blocking device in a blocking position.

FIG. 9 shows an isometric view of the housing portion according to FIG. 8 with the blocking device in a release position.

FIG. 10 shows a plan view of the housing portion according to FIG. 8.

FIG. 11 shows an isometric view of a filter element according to an embodiment of the invention.

FIG. 12 shows an isometric view of a blocking device according to an embodiment of the invention.

FIG. 13 shows an isometric view of a blocking device according to a further embodiment of the invention.

FIG. 14 shows an isometric view of a filter element according to a further embodiment of the invention.

FIG. 15 shows an isometric view of a filter element according to a further embodiment of the invention.

FIG. 16 shows an isometric view of a filter element according to a further embodiment of the invention.

### DETAILED DESCRIPTION

In the drawing figures same or same-type components are identified with like reference characters. The drawing figures show only examples and are not to be understood as limiting.

For reasons of clarity, not all same-type elements are provided with reference characters but only some of the same-type elements are provided with reference characters in an exemplary fashion.

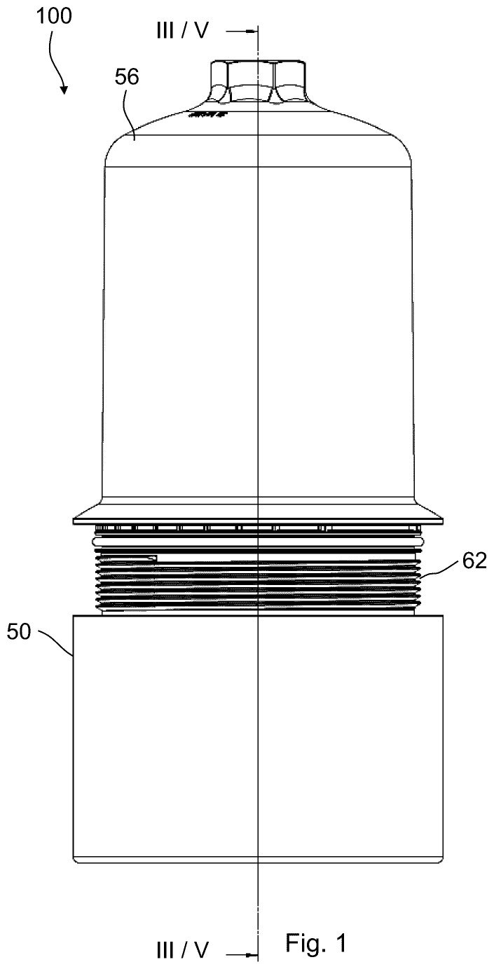

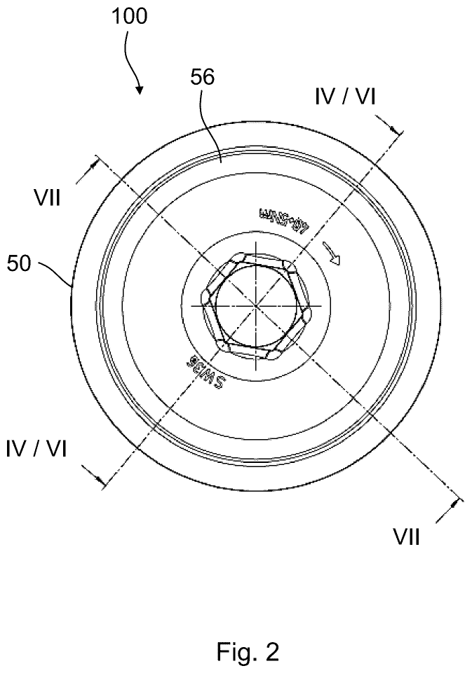

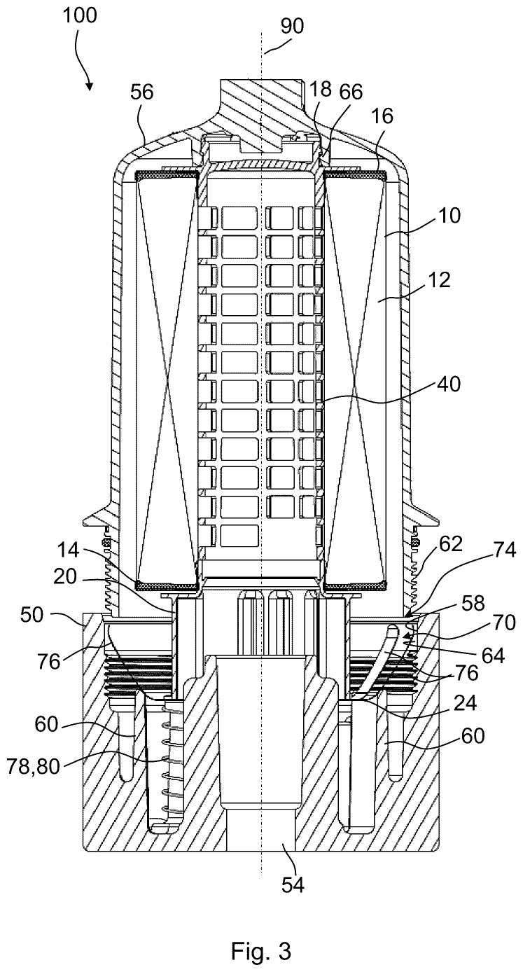

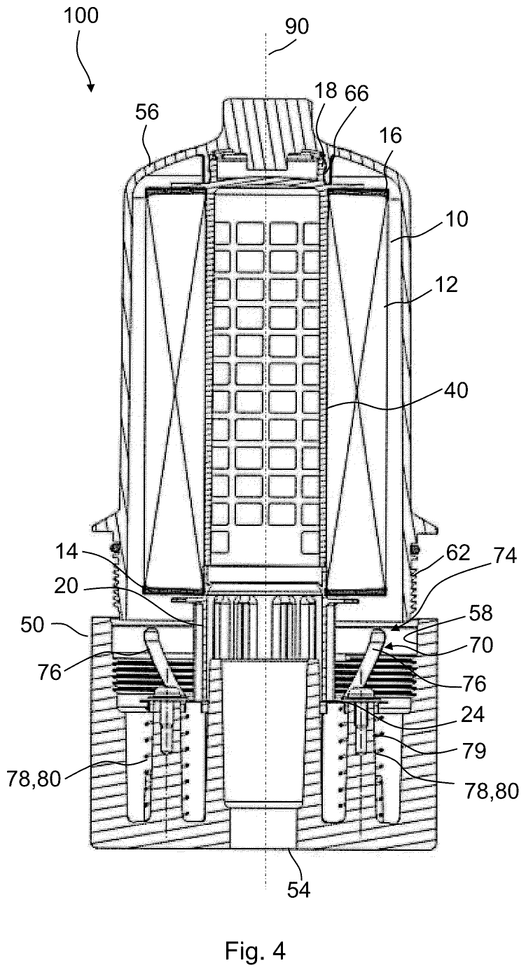

For explaining the invention, FIG. 1 shows a side view of a filter device 100 for a fluid, for example for a liquid fluid, according to an embodiment of the invention with housing cover 56 unscrewed. FIG. 2 shows a plan view of the housing cover 56 of the filter device 100 and FIG. 3 a section illustration of the filter device 100 in the section plane III-III according to FIG. 1. FIG. 4 shows a further section illustration of the filter device 100 in the section plane IV-IV according to FIG. 2.

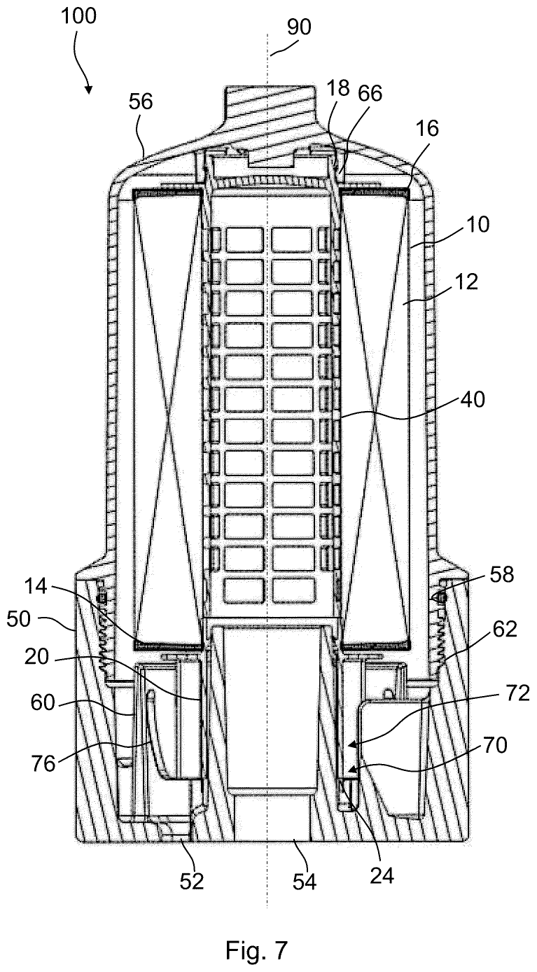

The filter device 100 comprises a housing portion 50 which comprises an inlet 52 (visible in FIG. 7) for the fluid to be filtered and a central outlet 54 for the filtered fluid. A housing cover 56 which is configured to receive an exchangeable filter element 10 in its interior may be connected by a screw thread 62, 64 to the housing portion 50. The filter element 10 comprises at its upper end an at least partially circumferentially extending connection element 18, for example, a locking element, with which the filter element 10 may interact with an at least partially circumferentially extending counter element 66 arranged at the housing cover 56 and is fixed in the housing cover 56 in this way.

An installation position of the filter device 100 may be selected as desired. The filter device 100 may be installed upright or horizontally or at a slant. In this context, in the installed state of the filter device 100 the housing cover 56 may be arranged above the housing portion 50 or below or, in case of horizontal installation, at the same level, depending on the boundary conditions at the installation site.

The filter element 10 comprises a filter medium body 12 which is mounted on a central tube 40. The filter medium body 12 is closed off at both ends by end discs 14, 16, for example, plastic end discs. As intended, the filter element 10 is flowed through by the fluid to be filtered in radial direction from the exterior to the interior. The filtered fluid may be guided through the interior of the central tube 40 to the exterior via the outlet 54.

The housing portion 50 comprises a blocking device 70 which is operatively connected to an actuation device 20 of the filter element 10 when the housing cover 56 is connected as intended to the housing portion 50. The blocking device 70 permits mounting of the housing cover 56 in a release position 72 and blocks mounting of the housing cover 56 in a blocking position 74.

The blocking device 70 surrounds the outlet 54 in the housing portion 50 and is slidable in the housing axis 90 between the release position 72 and the blocking position 74. The blocking device 70 may be moved, for example slid, into the release position 72 by the actuation device 20 with the filter element 10 arranged in the housing cover 56 when the housing cover 56 is mounted. The blocking device 70 is in the blocking position 74 when not operatively connected to the actuation device 20. For example, the blocking device 70, when not operatively connected to the actuation device 20, may be transferred by spring force of a spring element 78, for example, a pressure spring 80 (see FIGS. 3 and 4) or a leaf spring (see FIG. 13), automatically from the release position 72 to the blocking position 74.

The blocking device 70 is spring-biased in the blocking position 74. For this purpose, the blocking device 70 comprises at least two spring arms 76 which protrude in radial direction. The spring arms 76 may rest against an inner housing wall 58 in the blocking position 74.

In FIGS. 3 and 4, the blocking device 70 is illustrated in the blocking position 74.

The actuation device 20 surrounds the outlet 54 when mounted as intended. In this context, a bottom rim 24 of the actuation device 20 may displace the blocking device 70 in the housing axis 90 direction when mounted as intended. The actuation device 20 may be configured as part of the central tube 40 of the filter element 10, as illustrated in the embodiment in FIGS. 3 and 4, or as part of the end disc 14 of the filter element 10.

The blocking device 70 comprises spring elements 78 which act for example in the housing axis 90 direction and by means of which the blocking device 70, when not operatively connected to the actuation device 20, is moved from the release position 72 into the blocking position 74. The spring elements 78, as illustrated in the embodiment, may be designed as pressure springs 80 which are arranged around guide sleeves 79. The blocking device 70 may be guided by the guide sleeves 79 for example in the displacement movement from the blocking position 74 into the release position 72 and in reverse.

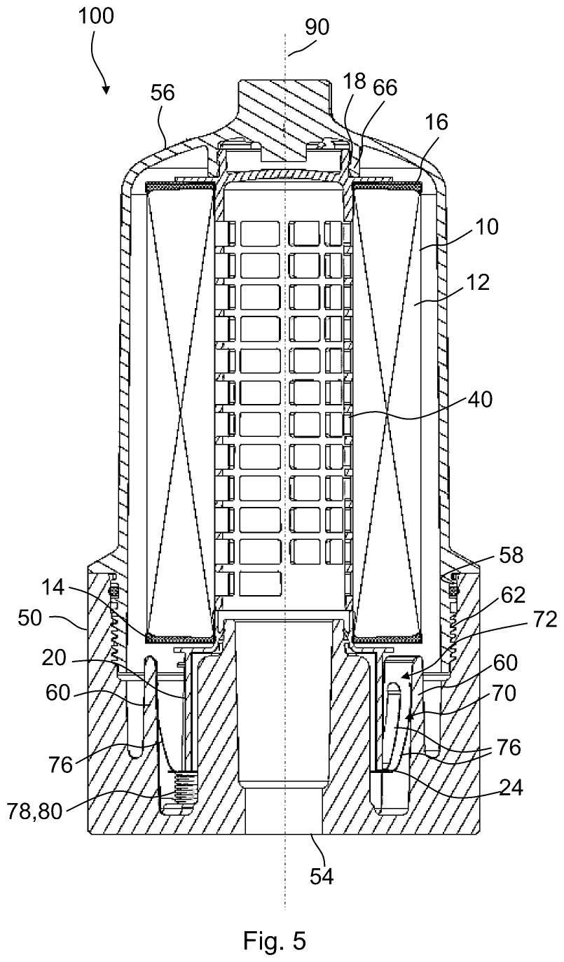

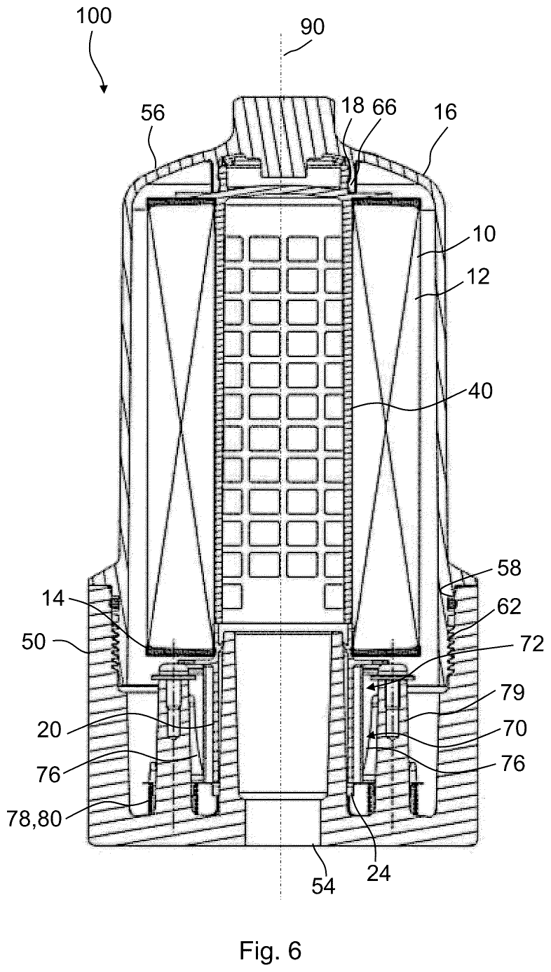

FIG. 5 shows the filter device 100 in the mounted state with screwed-in housing cover 56 in the section plane V-V according to FIG. 1. FIG. 6 shows a further section illustration of the filter device 100 in the mounted state in the section plane VI-VI according to FIG. 2. FIG. 7 shows a further section illustration of the filter device 100 in the mounted state in the section plane VII-VII according to FIG. 2.

The housing cover 56 with inserted filter element 10 is mounted on the housing portion 50. The thread 62 of the housing cover 56 engages the counter thread 64 of the housing portion 50. In this way, the blocking device 70 is moved by the bottom rim 24 of the actuation device 20 from the blocking position 74 into the release position 72.

In FIGS. 5 and 6, the blocking device 70 may be seen in the release position 72. The pressure spring 80 is compressed by the blocking device 70 which is pushed downwardly in FIGS. 5, 6 by the bottom rim 24 of the actuation device 20.

In FIG. 7, the inlet 52 for the fluid to be filtered is arranged at the bottom side adjacent to the outlet 54 in the housing portion 50. The fluid passes through the inlet 52 into the housing portion 50 and flows through the filter medium body 12 in radial direction from the exterior to the interior. The filtered fluid is drained through the interior of the filter medium body 12 to the outlet 54.

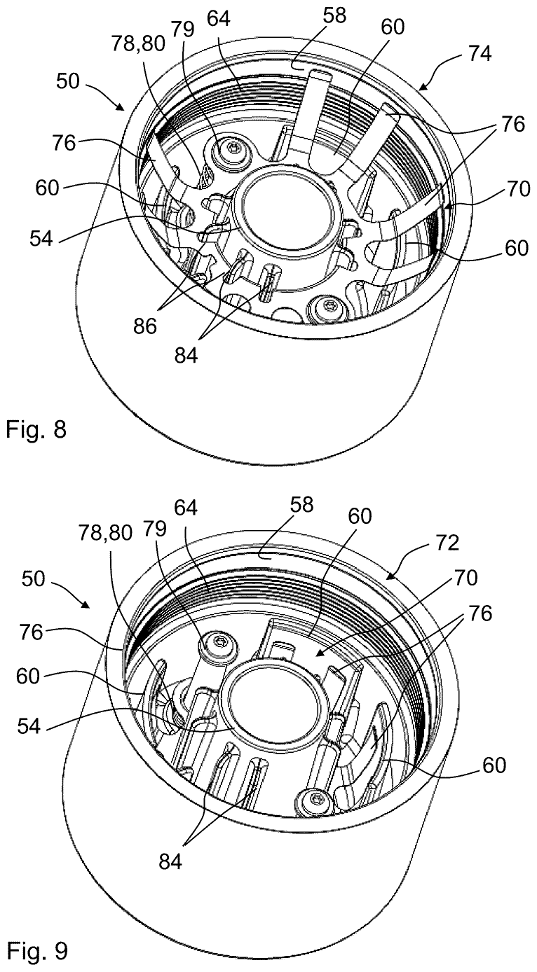

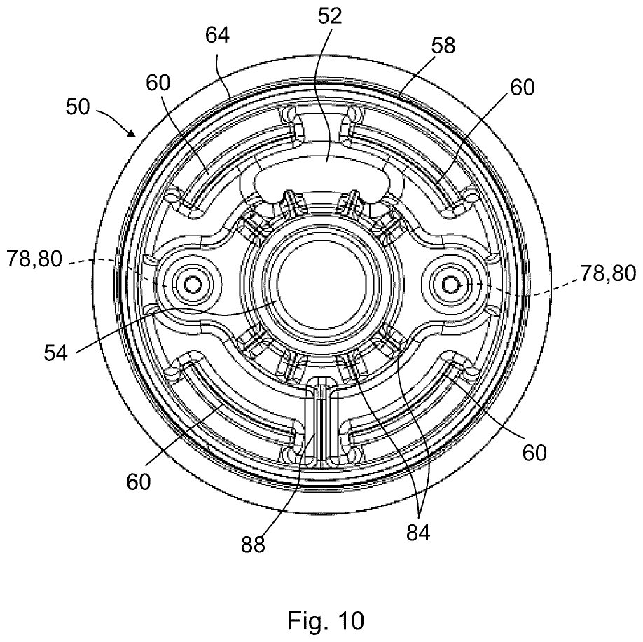

FIG. 8 shows an isometric view of the housing portion 50 according to an embodiment of the invention with the blocking device 70 in the blocking position 74 while in FIG. 9 the housing portion with the blocking device 70 is illustrated in the release position 72. FIG. 10 shows a plan view of an interior of the housing portion 50.

The housing portion 50 comprises axially arranged guide elements 60 by means of which the spring arms 76 of the blocking device 70, when passing from the blocking position 74 into the release position 72, are disengaged from the inner housing wall 58 and folded inwardly in radial direction. When the blocking device 70 is pushed downwardly in the housing portion 50 by the actuation device 20 of the filter element 10, the spring arms 76 glide, or slide, along the guide elements 60 and are forced to fold inwardly in this way.

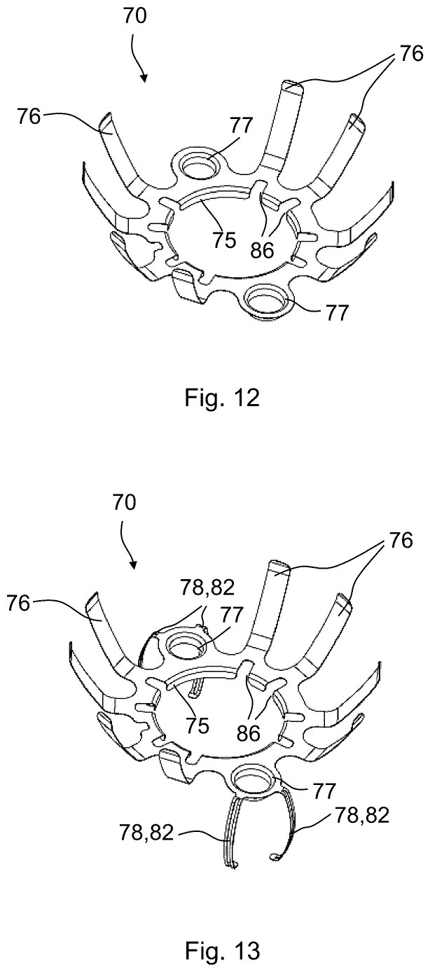

As seen also in FIGS. 8 and 9, the outlet 54 comprises a plurality of radially protruding guide ribs 84 extending in the housing axis 90 direction. The blocking device 70 comprises cutouts 86 corresponding therewith (also visible in FIG. 12). In this context, the blocking device 70 with at least one cutout 86 may be moved along the guide rib 84.

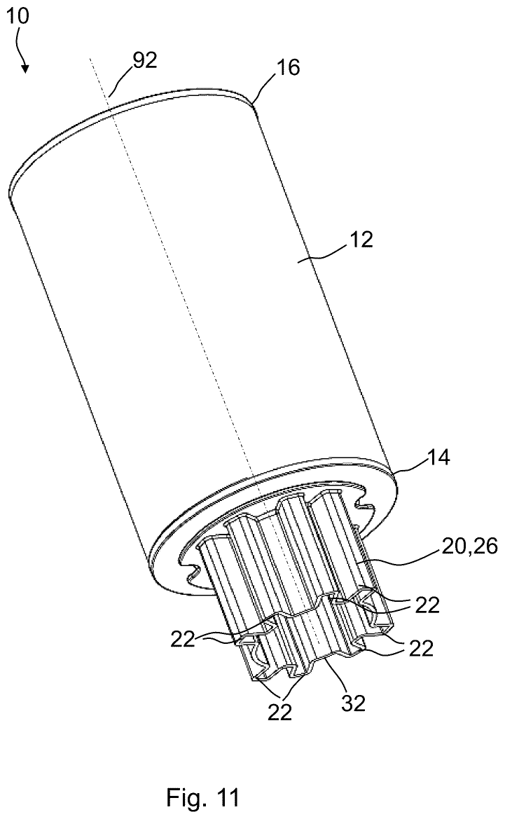

As may be seen for example in FIG. 10, the housing portion 50 comprises at least one positioning element 88 which protrudes in radial direction inwardly and extends in the housing axis 90 direction. The actuation device 20 of the filter element 10 comprises at least one recess 32 (see FIG. 11) which is engaged by the positioning element 88 when the filter element 10 is mounted as intended.

FIG. 11 shows an isometric view of a filter element 10 according to an embodiment of the invention.

The filter element 10 comprises a filter medium body 12 which is closed off by an end disc 14, 16 at both ends. As an extension of a central tube 40, not visible, or alternatively also of the lower end disc 14, the actuation device 20 protrudes axially from the lower end in an axial direction 92. The actuation device 20 in this embodiment is configured as a contour 26 which is closed in the axial direction 92.

The actuation device 20 comprises guide receptacles 22 formed by its outer contour which correspond with the guide ribs 84 of the housing portion 50 when mounted as intended. When the housing cover 56 with the filter element 10 is mounted as intended, the guide ribs 84 interact with the filter element 10 provided with the guide receptacles 22 and engage the guide receptacles 22. Between two guide receptacles 22 at oppositely positioned sides of the actuation device 20, a recess 32 is arranged, respectively, which is engaged by the positioning element 88 of the housing portion 50 when the filter element 10 is mounted as intended.

FIG. 12 shows an isometric view of a blocking device 70 according to an embodiment of the invention.

The blocking device 70 may be designed as a spring-biased sheet-metal structure with a flower-like structure, for example. The spring arms 76 which protrude like flower petals rest against the inner housing wall 58 of the housing portion 50 in the blocking position 74, as seen in FIG. 8. The blocking device 70 comprises a central opening 75 with which it is slidable on the outlet 54 in the housing axis 90 direction. The cutouts 86, by means of which the blocking device 70 is slidable on the guide ribs 84 of the housing portion 50, extend away from the central opening 75 in radial direction.

Guide eyes 77 positioned opposite each other protrude away from the circumference of the blocking device 70; with them, the blocking device 70 rests on the pressure springs 80 and glides/slides along the guide sleeve 79 (see FIGS. 8 and 9).

FIG. 13 shows an isometric view of a blocking device 70 according to a further embodiment of the invention.

Two leaf springs 82 are arranged here at the guide eyes 77 which in this alternative embodiment ensure that the blocking device 70 is pushed automatically into the blocking position 74. In this embodiment, the pressure springs 80 around the guide sleeves 79 may be omitted.

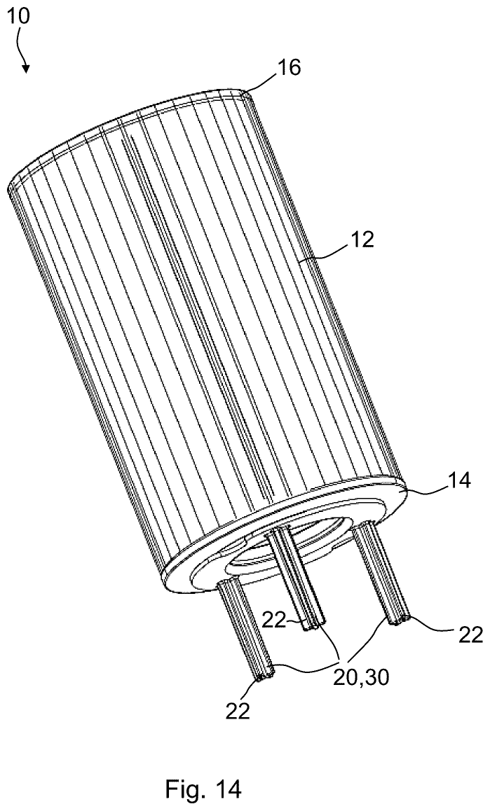

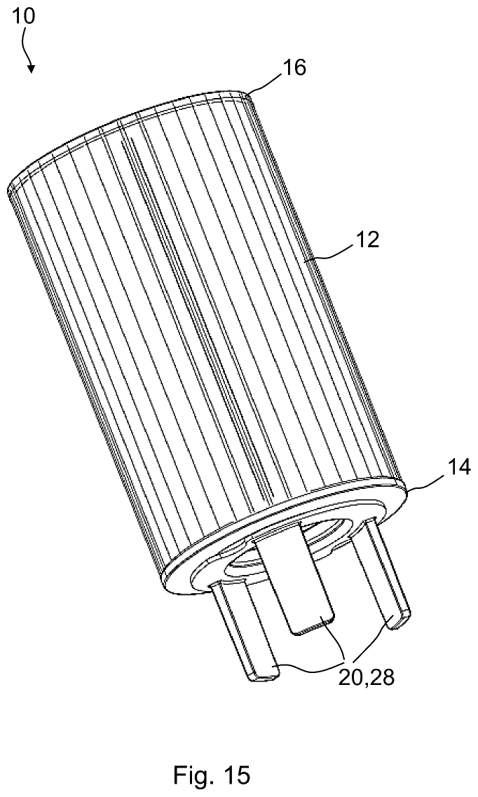

In FIGS. 14 to 16, filter elements 10 with alternative embodiments of the actuation device 20 are illustrated.

FIG. 14 shows an actuation device 20 which is configured as individual pins 30 which, when mounting as intended, push on the blocking device 70 on a circumference around the outlet 54 of the housing portion 50 and, in this context, move the blocking device 70 into the release position 72. Along a radially inner contour of the pins 30, guide receptacles 22 in the form of grooves may be arranged, respectively.

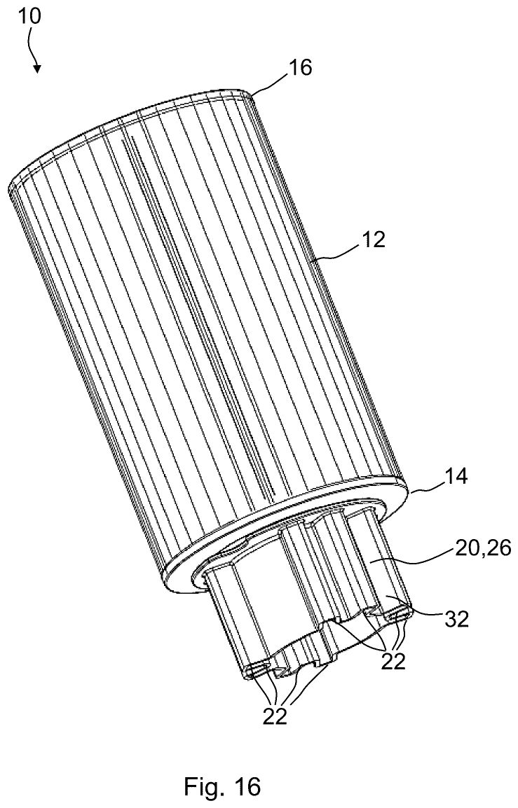

FIG. 15 shows an actuation device 20 which is configured in the form of stays 28, while in FIG. 16 an actuation device 20 with a closed contour 26 is shown.

In contrast to the embodiments of the actuation device 20 in the form of the pins 30 or stays 28, in the embodiment with the closed contour 26, a recess 32 may be provided, respectively, which may be engaged by a positioning element 88 arranged in the housing portion 50 and thus may guarantee a position-correct and unequivocal positioning of the filter element 10 in the housing portion 50.

### REFERENCE CHARACTERS

10 filter element
12 filter medium body
14 end disc
16 end disc
18 connection element
20 actuation device
22 guide receptacle
24 bottom rim
26 closed contour
28 stay
30 pin
32 recess
40 central tube
50 housing portion
52 inlet
54 outlet
56 housing cover
58 inner housing wall
60 guide element
62 thread
64 counter thread
66 counter element
70 blocking device
72 release position
74 blocking position
75 central opening
76 spring arm
77 guide eye
78 spring element
79 guide sleeve
80 pressure spring
82 leaf spring
84 guide rib
86 cutout
88 positioning element
90 housing axis
92 axial direction
100 filter device

That which is claimed is:

1. A filter device comprising:
a housing portion comprising at least one inlet for a fluid to be filtered and at least one central outlet for the filtered fluid;
a housing cover comprising an interior and configured to receive an exchangeable filter element in the interior;
wherein the housing portion is configured to connect to the housing cover;
wherein the housing portion comprises a blocking device operatively connected to an actuation device of the filter element when the housing cover is connected to the housing portion; and
wherein the blocking device comprises a release position and a blocking position, wherein the blocking device permits mounting of the housing cover in a release position and blocks mounting of the housing cover in a blocking position.

2. The filter device according to claim 1, wherein the blocking device is arranged in the housing portion to surround the at least one central outlet and is configured to slide along a housing axis between the release position and the blocking position; and
wherein the blocking device is configured to be moved by the actuation device of the filter element from the blocking position into the release position.

3. The filter device according to claim 2, wherein the blocking device, when not operatively connected to the actuation device of the filter element, is in the blocking position.

4. The filter device according to claim 3, wherein the blocking device, when not operatively connected to the actuation device, automatically moves from the release position into the blocking position.

5. The filter device according to claim 2, wherein the blocking device comprises at least two spring arms protruding in a radial direction in relation to the housing axis, and wherein the at least two spring arms rest against an inner housing wall of the housing portion in the blocking position.

6. The filter device according to claim 5, wherein the housing portion comprises axially arranged guide elements, and wherein the at least two spring arms are disengaged from the inner housing wall and folded inwardly in the radial direction when the blocking device moves from the blocking position into the release position.

7. The filter device according to claim 1, wherein the blocking device comprises at least one spring element, wherein the at least one spring element is configured to automatically move the blocking device, when not operatively connected to the actuating device of the filter element, from the release position into the blocking position.

8. The filter device according to claim 7, wherein the at least one spring element acts in a housing axis direction of the filter device.

9. The filter device according to claim 1, wherein the at least one central outlet comprises one or more radially protruding guide ribs extending in a housing axis direction of the filter device, wherein the blocking device comprises one or more cutouts corresponding to the one or more radially protruding guide ribs, and wherein the blocking device is configured to slide with the one or more cutouts axially along the one or more radially protruding guide ribs.

10. The filter device according to claim 9, wherein the actuation device of the filter element comprises guide receptacles corresponding to the one or more radially protruding guide ribs, and wherein the one or more radially protruding guide ribs, when the housing cover with the filter element is mounted on the housing portion, interact with the guide receptacles.

11. The filter device according to claim 10, wherein the one or more radially protruding guide ribs engage the guide receptacles.

12. The filter device according to claim 1, wherein the housing portion comprises at least one positioning element protruding inwardly in a radial direction in relation to a housing axis of the filter element and extending in the housing axis direction, wherein the actuation device of the filter element comprises at least one recess, and wherein the at least one positioning element engages the at least one recess when the filter element is mounted on the housing portion.

13. The filter device according to claim 1, wherein the actuation device of the filter element surrounds the at least one central outlet when mounted on the housing portion, and wherein a bottom rim of the actuation device of the filter element displaces the blocking device in a housing axis direction.

14. The filter device according to claim 13, wherein the actuation device of the filter element comprises a circumferentially closed contour extending along the housing axis direction.

15. The filter device according to claim 13, wherein the actuation device of the filter element comprises stays and/or pins, and wherein the stays and/or pins extend along the housing axis direction.

16. The filter device according to claim 1, wherein the actuation device of the filter element is configured as a part of a central tube of the filter element and/or as a part of an end disc of the filter element.

17. A housing portion for a filter device comprising a housing cover configured to receive a filter element comprising an actuation device, the housing portion comprising:
at least one inlet for a fluid to be filtered and at least one central outlet for the filtered fluid;
a blocking device configured to be operatively connected to the actuation device of the filter element when the housing cover is mounted to the housing portion;
wherein the blocking device comprises a release position and a blocking position, wherein the blocking device permits mounting of the housing cover in the release position and blocks mounting of the housing cover in the blocking position.

18. A filter element for the filter device according to claim 1, wherein the filter element is configured to be received in the interior of the housing cover of the filter device, wherein the housing cover is configured to be mounted, together with the filter element, on the housing portion of the filter device, the filter element comprising an actuation device, wherein the actuation device, when the housing cover of the filter device is mounted to the housing portion, is operatively connected to the blocking device of the housing portion of the filter device.
